(19) United States
(12) Patent Application Publication
(10) Pub. No.: US 2018/0004143 A1
(43) Pub. Date: Jan. 4, 2018

(54) PRINTING APPARATUS

(71) Applicant: SEIKO EPSON CORPORATION, Tokyo (JP)

(72) Inventor: Tsuneyuki SASAKI, Matsumoto-shi (JP)

(21) Appl. No.: 15/637,754

(22) Filed: Jun. 29, 2017

(30) Foreign Application Priority Data
Jun. 29, 2016 (JP) 2016-129020

(51) Int. Cl. G03G 15/00; G03G 15/23

(52) U.S. Cl. CPC G03G 15/605; G03G 15/6558; G03G 15/234; G03G 2215/00675; G03G 2215/00016

(57) ABSTRACT

A printing apparatus includes a guide unit provided with a guide surface configured to guide a medium by coming into contact with the medium on which printing has been performed, and a heating unit disposed to face the guide surface with a space therebetween. The heating unit includes a first opening portion that opens toward the guide surface on an upstream side in a transport direction, a second opening portion that opens toward the guide surface on a downstream side in the transport direction, a duct connecting the first opening portion and the second opening portion, and a first blowing unit disposed inside the duct. The printing apparatus switches a direction of airflow produced in a heating region in response to a switching of a blowing direction of the first blowing unit.

### BACKGROUND

### 1. Technical Field

The Embodiments of the present invention relates to a printing apparatus such as an ink jet printer.

### 2. Related Art

In the related art, printing apparatuses configured to print images by discharging ink onto a media such as a sheet transported in a transport direction are known. Among such printing apparatuses, there is a printing apparatus that includes an after-platen (guide unit) configured to guide a medium on which printing has been performed, and an after-heating unit (heating unit) disposed to face the after-platen and configured to heat the medium guided to the after-platen (JP-A-2013-166271, for example).

In the after-platen of such a printing apparatus described above, a transportation defect may occur in which the transportation of the medium on which printing has been performed is disrupted in a region between the after-platen and the after-heating unit in association with the medium becoming attached to the after-platen when transported.

However, a space between the after-platen and the after-heating unit is generally narrowed in order to increase a heating efficiency of the medium, making it problematically difficult for the user of the printing apparatus to resolve a transportation defect that occurs in the region between the after-platen and the after-heating unit.

### SUMMARY

Hereinafter, a description is given of the means for solving the problem and the advantages of the embodiments of the invention.

A printing apparatus configured to resolve the above-described problems includes a printing unit configured to print on a medium, a transport unit configured to transport the medium in a transport direction, a guide unit that is increasingly directed vertically downward while advancing in the transport direction and includes a guide surface configured to guide the medium by coming into contact with the medium on which printing has been performed, and a heating unit disposed to face the guide surface with a space therebetween and configured to contactlessly heat the medium. The heating unit includes a first opening portion that opens toward the guide surface on an upstream side in the transport direction, a second opening portion that opens toward the guide surface on a downstream side in the transport direction, a duct connecting the first opening portion and the second opening portion, and a blowing unit disposed inside the duct and capable of switching a blowing direction inside the duct. A direction of airflow produced in a heating region between the guide surface and the heating unit is switched in response to the switching of the blowing direction of the blowing unit.

According to the configuration described above, when a transportation defect caused by attachment of the medium to the guide surface or the like occurs in the heating region, the blowing unit is made to blow air inside the duct from the second opening portion toward the first opening portion, circulating the air in the order of the duct, the first opening portion, the heating region, and the second opening portion. Then, in the heating region, an airflow is produced in the transport direction, making it possible to apply, onto the medium, a force that moves the section where the transportation defect of the medium occurred in the transport direction. Thus, even when a transportation defect of the medium occurs in the heating region, the section where the transportation defect occurred is moved in the transport direction, making it possible to easily resolve the transportation defect.

Further, when a transportation defect has not occur and the medium on which printing has been performed is heated in the heating region, the blowing unit is made to blow air inside the duct from the first opening portion toward the second opening portion, circulating the air in the order of the duct, the second opening portion, the heating region, and the first opening portion. Then, in the heating region, an airflow is produced in the direction opposite to the transport direction. That is, in this case, the direction in which high-temperature air rises in the heating region and the direction of airflow produced in the heating region by the blowing unit coincide, thereby improving the ease at which the high-temperature air circulates and making it possible to heat the medium efficiently by heat transmission.

The above-described printing apparatus preferably further includes a detecting unit configured to detect a transportation defect of the medium in the heating region. The blowing unit is driven under first driving conditions when a transportation defect of the medium is not detected in the heating region, and under second driving conditions when a transportation defect of the medium is detected in the heating region. The first driving conditions are defined as the blowing unit blowing air inside the duct from the first opening portion toward the second opening portion, and the second driving conditions are defined as the blowing unit blowing air inside the duct from the second opening portion toward the first opening portion.

According to the configuration described above, the driving conditions of the blowing unit can be switched on the basis of the detection result from the detecting unit. Thus, when a transportation defect occurs in the heating region during the heating of the medium on which printing has been performed and guided on the guide surface, the transportation defect can be resolved without the user switching the driving conditions of the blowing unit.

In the printing apparatus described above, the guide surface preferably includes an air blowout hole configured to blow out air toward the heating region.

According to the configuration described above, the medium attached to the guide surface can be separated by the air blown out from the air blowout hole. Thus, a transportation defect that occurs in association with attachment of the medium to the guide surface can be easily resolved.

In the printing apparatus described above, the air blowout hole is preferably a slit hole provided in a plurality to the guide surface and arranged with a direction formed between a width direction and the transport direction of the medium serving as a longitudinal direction.

When the air blowout hole is a vertical slit hole with the transport direction serving as the longitudinal direction, both end portions of the medium in the width direction decline into the vertical slit holes in the transport direction, possibly causing a transportation defect of the medium. Further, when the air blowout hole is a horizontal slit hole with the width direction serving as the longitudinal direction, a leading end portion of the medium declines into the horizontal slit holes in the width direction, possibly causing a transportation defect of the medium. According to the configuration described above, the air blowout hole is a slit hole in which the direction formed between the width direction and the transport direction serves as the longitudinal direction, making the end portions of the medium less susceptible to decline into the slit holes and thus transportation defects are less likely to occur.

In the printing apparatus described above, the printing apparatus preferably further includes a vibration unit configured to vibrate the guide surface.

According to the configuration described above, when the medium attaches to the guide surface, causing a transportation defect, the vibration unit vibrates the guide surface, making it possible to separate the medium from the guide surface. As a result, compared to when the transportation defect is resolved by the airflow produced by the blowing unit alone, the transportation defect can be easily resolved.

### BRIEF DESCRIPTION OF THE DRAWINGS

The embodiments of the invention will be described with reference to the accompanying drawings, wherein like numbers reference like elements.

FIG. 1 is a side view of a printing apparatus according to an exemplary embodiment.

FIG. 2 is a side view of a guide unit and a heating unit of the printing apparatus.

FIG. 3 is a view of the guide unit from a direction orthogonal to a guide surface.

FIG. 4 is a flowchart illustrating processing executed by a control unit in response to a state of occurrence of a transportation defect.

FIG. 5 is a side view of the guide unit and the heating unit when a transportation defect has not occur.

FIG. 6 is a side view of the guide unit and the heating unit when a transportation defect occurs.

### DESCRIPTION OF EMBODIMENTS

An exemplary embodiment of a printing apparatus is described below while referencing the accompanying drawings. Note that the printing apparatus of the present exemplary embodiment is an ink jet printer configured to form characters and images by discharging ink onto a medium such as a sheet.

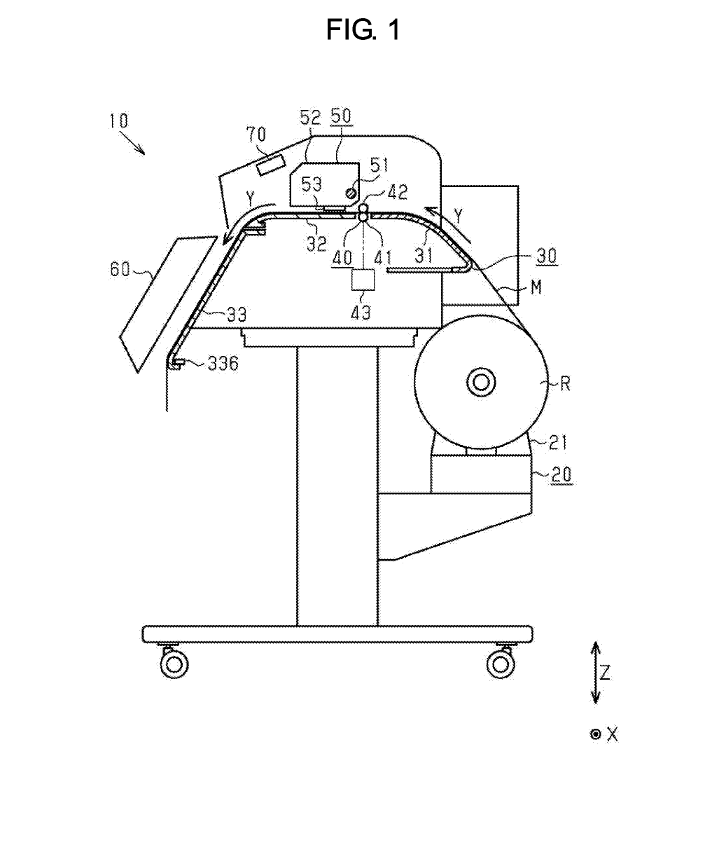

As illustrated in FIG. 1, a printing apparatus 10 is provided with a feeding unit 20 configured to feed a medium M, a support unit 30 configured to support the medium M, a transport unit 40 configured to transport the medium M, a printing unit 50 configured to print on the medium M, a heating unit 60 configured to heat the medium M, and a control unit 70 configured to control the driving of the various constituents.

In the following description, a width direction of the printing apparatus 10 is referred to as a “width direction X,” a direction in which the medium M is transported is referred to as a “transport direction Y,” and a vertical direction of the printing apparatus 10 is referred to as a “vertical direction Z.” In the exemplary embodiment, the width direction X is a direction orthogonal to both the transport direction Y and the vertical direction Z. Further, the width direction X of the printing apparatus 10 is also the width direction X of the medium M printed by the printing apparatus 10.

The feeding unit 20 includes a holding member 21 configured to rotatably hold a roll R on which the medium M is wound. The holding member 21 holds different types of media M and rolls R with different dimensions in the width direction X. Moreover, the medium M is unwound from the roll R and fed toward the support unit 30 by rotating the roll R in one direction (the counter-clockwise direction in FIG. 1) at the feeding unit 20.

The support unit 30 is provided with a first support unit 31, a second support unit 32, and a guide unit 33. These constituents form a transport path of the medium M. The first support unit 31, the second support unit 32, and the guide unit 33 are disposed side-by-side in the transport direction Y of the medium M. The first support unit 31 guides (supports) the medium M fed from the feeding unit 20 toward the second support unit 32, the second support unit 32 guides (supports) the medium M on which printing is to be performed, and the guide unit 33 guides (supports) the medium M on which printing has been performed downstream in the transport direction.

The transport unit 40 is provided with a driving roller 41 and a driven roller 42 having the width direction X serving as an axial direction, and a transport motor 43 that drives the driving roller 41. The driving roller 41 is disposed vertically below the transport path of the medium M, and the driven roller 42 is disposed vertically above the transport path of the medium M. Moreover, the transport unit 40 transports the medium M in the transport direction Y by rotating the driving roller 41 while the medium M is sandwiched between the driving roller 41 and the driven roller 42.

The printing unit 50 is provided with a guide shaft 51 that extends in the width direction X, a carriage 52 supported on the guide shaft 51, and a discharge unit 53 configured to discharge ink onto the medium M. The carriage 52 reciprocates in the width direction X along the guide shaft 51 by the driving of a carriage motor (not illustrated). The discharge unit 53 is an ink jet head on which a plurality of nozzles configured to discharge ink are formed, and is supported by the carriage 52 to face the second support unit 32. Moreover, in the printing unit 50, ink is discharged from the discharge unit 53 while the carriage 52 is moved in the width direction X, thereby printing one path on the medium M supported by the second support unit 32.

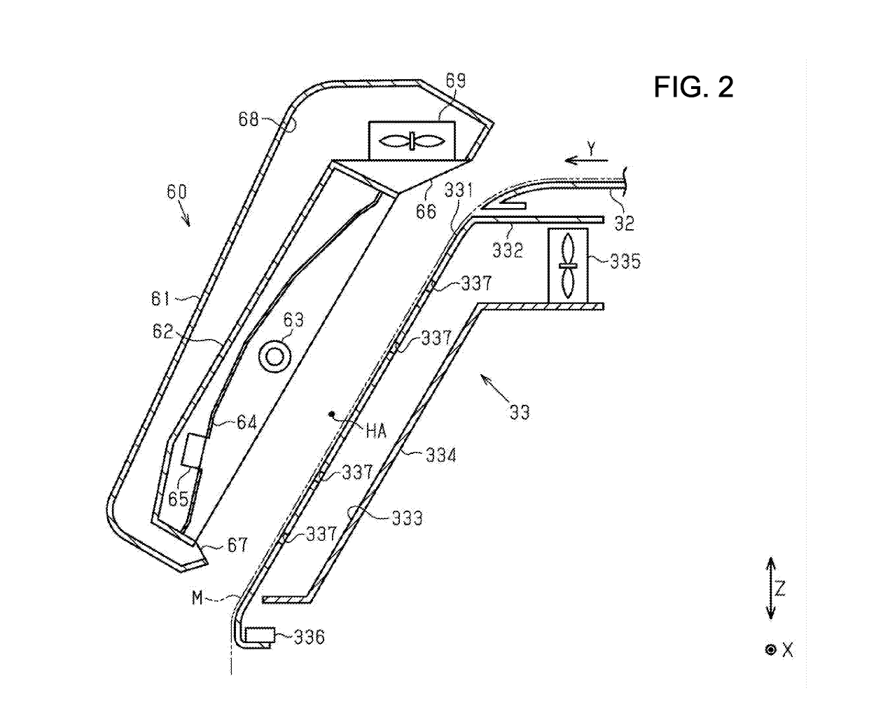

Next, the guide unit 33 and the heating unit 60 will be described in detail with reference to FIG. 2. Note that the guide unit 33 and the heating unit 60 are provided in the width direction X of the printing apparatus 10, with the width direction X of the printing apparatus 10 serving as the longitudinal direction.

As illustrated in FIG. 2, the guide unit 33 includes a guide surface forming member 332 on which is formed a guide surface 331 configured to guide the medium M by coming into contact with a back surface of the medium M, a flow path forming member 334 configured to form a flow path 333 along with the guide surface forming member 332, a second blowing unit 335 configured to blow air, and a vibration unit 336 configured to vibrate the guide surface 331.

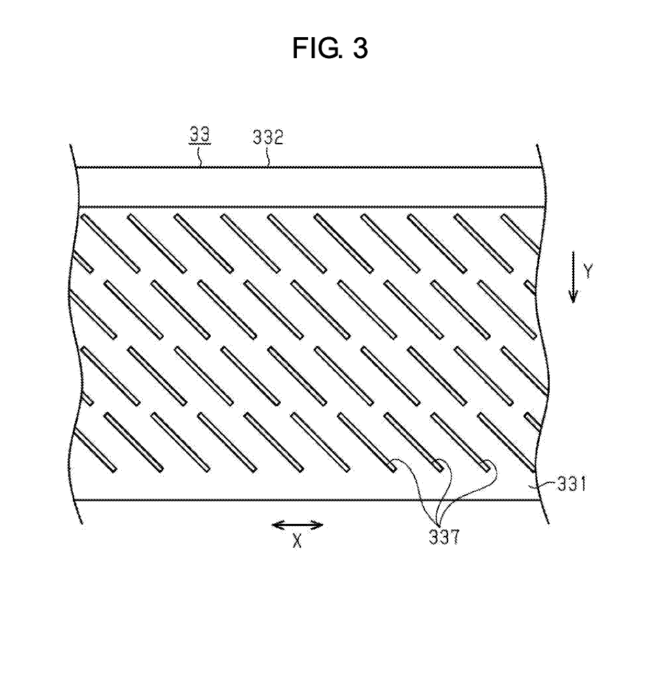

As illustrated in FIG. 2 and FIG. 3, the guide surface forming member 332 forms a substantially plate-like shape, and is disposed to form a transport path in sequence with the second support unit 32. As illustrated in FIG. 2, the guide surface 331 of the guide surface forming member 332 is increasingly directed vertically downward while advancing in the transport direction Y. Additionally, as illustrated in FIG. 3, the guide surface 331 of the guide surface forming member 332 is provided with a plurality of slit holes 337 arranged in the width direction X and the transport direction Y. The slit holes 337 are increasingly directed toward one end side in the width direction X while advancing in the transport direction Y. As a result, in the exemplary embodiment, the longitudinal direction of each of the slit holes 337 is a direction formed between the transport direction Y and the width direction X. Additionally, as illustrated in FIG. 2, each of the slit holes 337 penetrates the guide surface forming member 332, and communicate with the regions on both sides of the guide surface forming member 332.

As illustrated in FIG. 2, the flow path forming member 334 is disposed on the side opposite to the side where the transport path of the guide surface forming member 332 is formed, with a space therebetween. As a result, the flow path 333 is formed along the guide surface forming member 332, on the side opposite to the side of the guide surface forming member 332 where the transport path of the medium M is formed. Additionally, the flow path 333 communicates with a heating region HA, which is a region between the guide surface 331 and the heating unit 60, via the slit holes 337.

The second blowing unit 335 is disposed in an upstream portion of the flow path 333. The second blowing unit 335 preferably has a configuration that allows blowing in the direction in which the flow path 333 is formed and, for example, is preferably an air blowing fan such as an axial fan or a centrifugal fan. Further, only one or a plurality of the second blowing units 335 may be disposed in the width direction X.

The vibration unit 336 comes into contact with a surface of the guide surface forming member 332 where the guide surface 331 is not formed. Moreover, the vibration unit 336 vibrates the guide surface 331 (the guide surface forming member 332), applying vibration to the medium M guided to the guide surface 331. For example, the vibration unit 336 may produce vibration by driving a motor with a weight with a bias attached to an output shaft, or by a piezoelectric element that extends and contracts in response to an applied voltage. Note that a plurality of the vibration units 336 may be disposed with spaces in the width direction X and in the transport direction Y, or only one vibration unit 336 may be disposed.

In the guide unit 33, when air is blown onto the flow path 333 in association with the driving of the second blowing unit 335, the air is blown out from the slit holes 337 toward the heating region HA. In the exemplary embodiment, the slit hole 337 is equivalent to an example of the “air blowout hole” that blows out air toward the heating region HA.

Next, the heating unit 60 will be described in detail with reference to FIG. 2.

As illustrated in FIG. 2, the heating unit 60 is disposed to face the guide surface 331 of the guide unit 33, with a space therebetween. Additionally, the heating unit 60 is provided with an external housing 61 constituting an outside section, an internal housing 62 constituting an inside section, a heater 63 configured to heat the medium M by irradiating infrared rays onto the medium M, a reflector plate 64 configured to reflect the infrared rays, and a detecting unit 65 configured to detect the temperature of a detection region set on the guide surface 331.

The external housing 61 and the internal housing 62 form a substantially rectangular shape, with the width direction X serving as a longitudinal direction, the transport direction Y serving as a transverse direction, and the direction orthogonal to both the width direction X and the transport direction Y serving as a thickness direction. Additionally, the external housing 61 is slightly larger than the internal housing 62, and is connected with the internal housing 62, covering the internal housing 62 from the outside. The heater 63 and the reflector plate 64 are housed in the internal housing 62, and disposed in positions of the transport unit 40 that face the guide surface 331. Examples of the heater 63 include a ceramic heater and a carbon heater. The reflector plate 64 is disposed between the internal housing 62 and the heater 63, and reflects infrared rays, which are irradiated from the heater 63 toward the reflector plate 64, toward the guide surface 331. As a result, the surface of the reflector plate 64 that faces the guide surface 331 is preferably formed from a material having a high infrared ray reflection rate.

The detecting unit 65 is disposed in an opening formed in the reflector plate 64. The detecting unit 65 detects the temperature of the detection region by, for example, detecting the amount of infrared rays reflected from the detection region on the guide surface 331. Here, the detection region may be, for example, a region facing the heater 63 of the heating unit 60 on the guide surface 331, and a plurality may be provided in the width direction X, or a plurality may be provided in the transport direction Y. Note that when a region on the guide surface 331 is clearly susceptible to attachment of the medium M, making transportation defects more likely to occur, that region as well as the region upstream from that region in the transport direction are preferably defined as detection regions.

Additionally, as illustrated in FIG. 2, the heating unit 60 is provided with a first opening portion 66 that opens toward the guide surface 331 on an upstream side in the transport direction, a second opening portion 67 that opens toward the guide surface 331 on a downstream side in the transport direction, a duct 68 connecting the first opening portion 66 and the second opening portion 67, and a first blowing unit 69 configured to blow air. Note that the duct 68 is a flow path configured to make the air flow, and the first blowing unit 69 is an example of the “blowing unit.”

As illustrated in FIG. 2, the first opening portion 66, the second opening portion 67, and the duct 68 are formed between the external housing 61 and the internal housing 62. The first blowing unit 69 is disposed in a position near the first opening portion 66 inside the duct 68. Additionally, the first blowing unit 69 may be a centrifugal fan or an axial fan as long as the fan is capable of switching the blowing direction of the air inside the duct 68. Further, only one or a plurality of the first blowing units 69 may be disposed in the width direction X.

Note that, in the following description, the driving conditions when the first blowing unit 69 blows air inside the duct 68 from the first opening portion 66 toward the second opening portion 67 are referred to as “first driving conditions,” and the driving conditions when the first blowing unit 69 blows air inside the duct 68 from the second opening portion 67 toward the first opening portion 66 are referred to as “second driving conditions.” That is, in the exemplary embodiment, the blowing direction of the first blowing unit 69 switches according to the switching of the driving conditions of the first blowing unit 69.

Then, when the first blowing unit 69 is driven under the first driving conditions, the air is sucked from the heating region HA to the duct 68 via the first opening portion 66, and discharged from the duct 68 to the heating region HA via the second opening portion 67. Thus, when the first blowing unit 69 is driven under the first driving conditions, the air is circulated in the order of the heating region HA, the first opening portion 66, the duct 68, and the second opening portion 67, thereby producing an airflow in the heating region HA in the direction (hereinafter a “first direction F1”) opposite to the transport direction Y.

Then, in the heating unit 60, when the first blowing unit 69 is driven under the second driving conditions, the air is sucked from the heating region HA to the duct 68 via the second opening portion 67, and discharged from the duct 68 to the heating region HA via the first opening portion 66. Thus, when the first blowing unit 69 is driven under the second driving conditions, the air is circulated in the order of the heating region HA, the second opening portion 67, the duct 68, and the first opening portion 66, thereby producing an airflow in the heating region HA in the same direction (hereinafter a “second direction F2”) as the transport direction Y.

When the infrared rays are irradiated from the heater 63 in the heating unit 60 described above, the infrared rays are absorbed in the medium M guided on the guide surface 331 as well as the ink discharged onto the medium M, and the temperatures of the medium M and the ink rise. As a result, solvent components of the ink discharged onto the medium M evaporate, and the image printed onto the medium M becomes fixed to the medium M. Additionally, when the infrared rays are irradiated from the heater 63, the temperature of the heating region HA also rises, causing the temperature of the air circulated in the duct 68 and the heating region HA to also rise when the first blowing unit 69 is driven. Thus, when the first blowing unit 69 is driven, high-temperature airflow is produced in the heating region HA, causing the medium M guided on the guide surface 331 as well as the ink discharged onto the medium M to be heated by the heat transmission resulting from the airflow as well.

In this way, in the heating unit 60 of the exemplary embodiment, the medium M guided on the guide surface 331 as well as the ink discharged onto the medium M are efficiently heated by thermal radiation and heat transmission. That is, the heating unit 60 of the exemplary embodiment is configured to heat (contactlessly heat) the medium M without coming into contact with the medium M.

Next, the electrical configuration of the printing apparatus 10 will be described.

The detecting unit 65 is connected to an input-side interface of the control unit 70, and the transport motor 43, the discharge unit 53, the heater 63, the first blowing unit 69, and the second blowing unit 335 are connected to an output-side interface of the control unit 70.

Moreover, the control unit 70 controls the drive of the transport unit 40 (transport motor 43), thereby executing a transport operation in which the medium M is transported by a unit transport amount. Further, the control unit 70 controls the drive of the printing unit 50, thereby performing a discharge operation in which ink is discharged from the discharge unit 53 toward the medium M while the carriage 52 is moved in the width direction X. Then, the control unit 70 alternately performs the transport operation and discharge operation, causing printing to be performed on the medium M.

Further, the control unit 70 controls the heater 63 of the heating unit 60 on the basis of the detection result of the detecting unit 65. That is, the drive of the heater 63 is strengthened and weakened in response to the temperature of the detection region.

Furthermore, the control unit 70 determines whether or not a transportation defect has occurred in the detection region of the detecting unit 65, that is, in the heating region HA, on the basis of the detection result of the detecting unit 65. Here, when a transportation defect of the medium M occurs, the medium M lifts from the guide surface 331, decreasing the distance from the heater 63 to the lifted section of the medium M. As a result, the amount of absorption of the infrared rays increases in the lifted section of the medium M, causing the temperature of the lifted section of the medium M to readily increase. Here, given the temperature of the detection region when a transportation defect has not occurred as a reference temperature, the control unit 70 determines whether or not a transportation defect occurred by whether or not the temperature of the detection region is higher than the reference temperature. That is, the detecting unit 65 of the exemplary embodiment is also configured to detect a transportation defect of the medium.

Then, as in the exemplary embodiment, in the printing apparatus 10 provided with the heating unit 60 configured to heat the medium M on which printing has been performed, the medium M may become attached to the guide surface 331 in the heating region HA between the guide surface 331 and the heating unit 60, causing a transportation defect of the medium M.

Here, while the user of the printing apparatus 10 can perform an operation for resolving the transportation defect as long as the space between the guide surface 331 and the heating unit 60 is widened to the extent that allows performance of the operation, widening the space between the guide surface 331 and the heating unit 60 decreases the heating efficiency of the medium M by the heating unit 60. As a result, the space between the guide surface 331 and the heating unit 60 is generally narrowed and, when a transportation defect occurs in the heating region HA, the task of resolving the transportation defect tends to become difficult.

Here, in the exemplary embodiment, the control unit 70 produces an airflow in the second direction F2 in the heating region HA when a transportation defect occurs in the heating region HA, thereby separating the medium M from the guide surface 331 and resolving the transportation defect. Specifically, the control unit 70 applies an airflow in the second direction F2 (transport direction Y) to the section of the medium M lifted from the guide surface 331, causing the lifted section of the medium M to move in the transport direction Y.

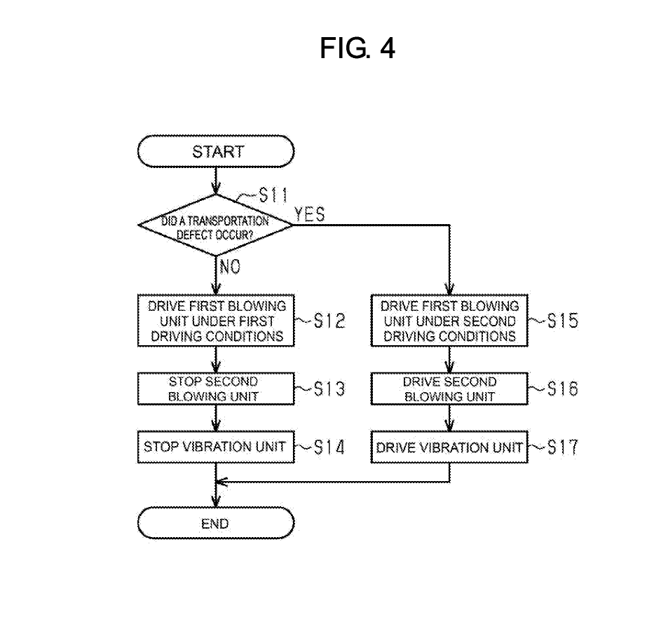

Next, the processing executed in order to make the control unit 70 control the drive of the first blowing unit 69 and the second blowing unit 335 in response to the state of occurrence of a transportation defect will be described with reference to the flowchart illustrated in FIG. 4. Note that the flowchart illustrated in FIG. 4 shows the processing executed for each predetermined control cycle after printing has started by the printing unit 50 and the heating of the medium M by the heating unit 60 has begun.

As illustrated in FIG. 4, the control unit 70 determines whether or not a transportation defect of the medium M has occurred in the heating region HA on the basis of the detection result of the detecting unit 65 (step S11). When a transportation defect has not occurred in the heating region HA (step S11: No), the control unit 70 drives the first blowing unit 69 under the first driving conditions (step S12), and produces an airflow in the first direction F1 in the heating region HA. Further, the control unit 70 stops the second blowing unit 335 provided to the guide unit 33 (step S13), ensuring that air is not blown from the slit holes 337 formed on the guide surface 331. The control unit 70 then stops the vibration unit 336 (step S14), ensuring that the guide surface 331 does not vibrate. Subsequently, the control unit 70 temporarily ends this series of processing.

On the other hand, when a transportation defect has occurred in the previous step S11 (step S11: Yes), the control unit 70 drives the first blowing unit 69 provided inside the heating unit 60 under the second driving conditions (step S15), and produces an airflow in the second direction F2 in the heating region HA. Further, the control unit 70 drives the second blowing unit 335 provided to the guide unit 33 (step S16), causing air to blow out from the slit holes 337 formed on the guide surface 331. The control unit 70 then drives the vibration unit 336 (step S17), vibrating the guide surface 331. Subsequently, the control unit 70 temporarily ends this series of processing.

Note that, in the flowchart illustrated in FIG. 4, although not stated, the control unit 70 stops the discharge operation by the printing unit 50 as well as the transport operation by the transport unit 40 when a transportation defect occurs (step S11: Yes).

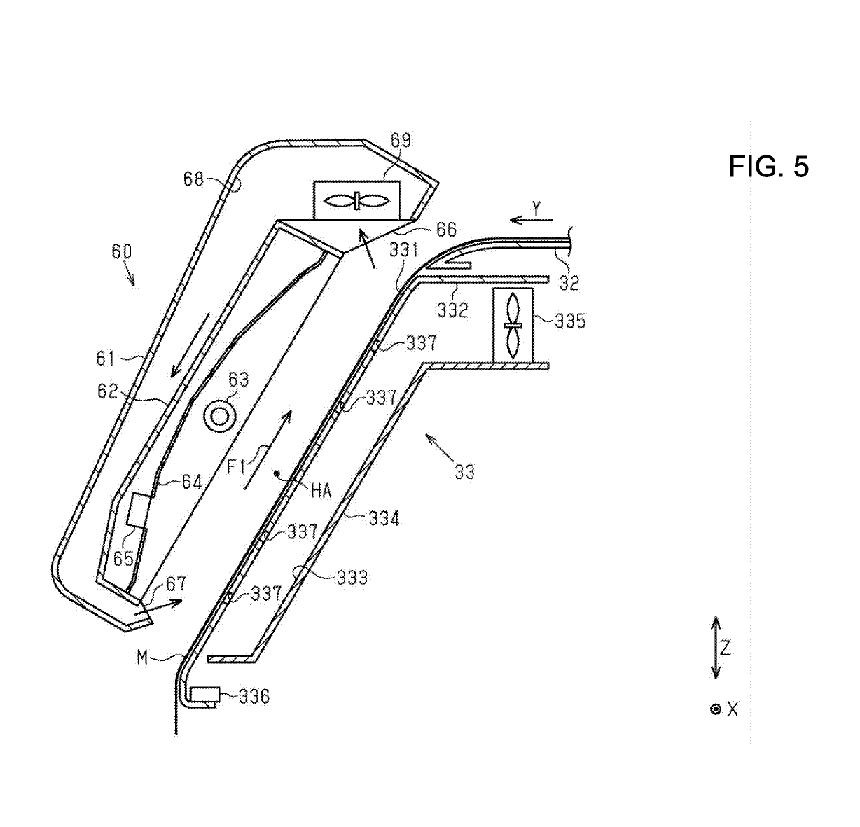

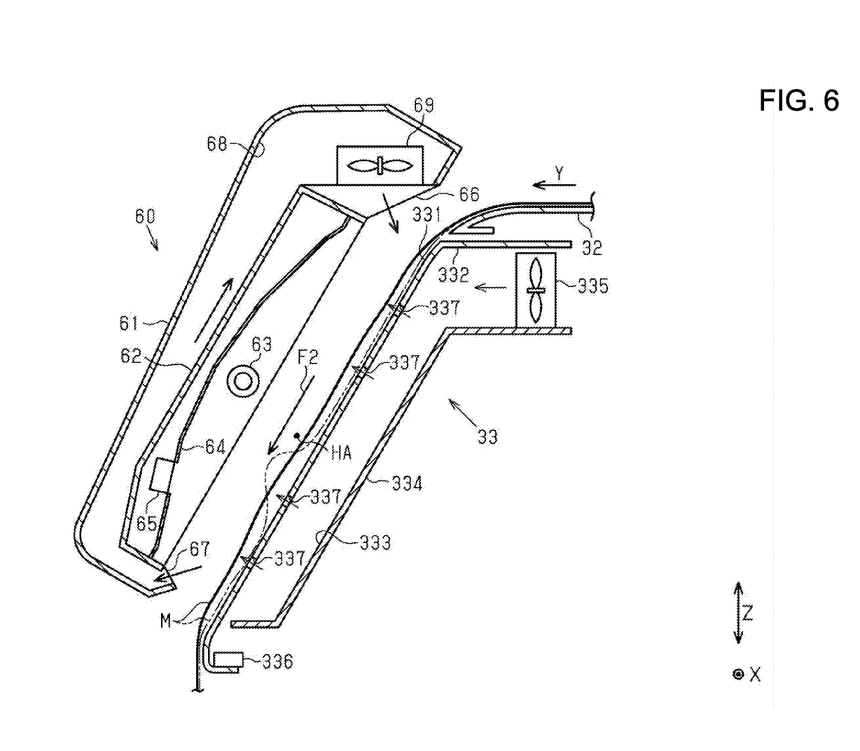

Next, a description of the operation of the printing apparatus 10 of the exemplary embodiment will be given with reference to FIG. 5 and FIG. 6.

When printing is performed on the medium M in the printing apparatus 10, the medium M fed from the feeding unit 20 is transported in the transport direction Y by the transport unit 40. Then, when the medium M reaches the second support unit 32, printing is performed by discharging ink from the printing unit 50 onto the medium M supported by the second support unit 32. Subsequently, when the medium M on which printing was performed is further transported in the transport direction Y by the transport unit 40, the medium M reaches the guide surface 331. The medium M supported by the guide surface 331 is then heated by the heating unit 60, causing the solvent components of the ink discharged onto the medium M to evaporate.

Specifically, as illustrated in FIG. 5, in the heating unit 60, infrared rays are irradiated from the heater 63, thereby heating the medium M guided on the guide surface 331. Further, the first blowing unit 69 is driven under the first driving conditions, causing high-temperature air (heated air) to circulate in the order of the first opening portion 66, the duct 68, the second opening portion 67, and the heating region HA, and an airflow to be produced in the first direction F1 in the heating region HA, as indicated by the solid arrows in FIG. 5.

Here, the direction of airflow (first direction F1) produced in the heating region HA coincides with the direction in which the high-temperature air rises in the heating region HA. As a result, the circulation efficiency of the high-temperature air increases, increasing the heating efficiency of the medium M by heat transmission. Thus, the medium M guided on the guide surface 331 is efficiently heated by the thermal radiation and heat transmission from the heating unit 60.

On the other hand, as illustrated in FIG. 6, when the medium M becomes attached to the guide surface 331 in the heating region HA, causing a transportation defect of the medium M, the first blowing unit 69 is driven under the second driving conditions. Then, high-temperature air circulates in the order of the second opening portion 67, the duct 68, the first opening portion 66, and the heating region HA, and an airflow is produced in the second direction F2 in the heating region HA, as indicated by the solid arrows in FIG. 6. As a result, an airflow is applied in the second direction F2 to the section of the medium M lifted from the guide surface 331, causing the lifted section of the medium M to move in the transport direction Y.

Further, when a transportation defect occurs, the second blowing unit 335 is driven, blowing the air from the slit holes 337 of the guide surface 331 toward the heating region HA, and thus applying a force that separates the medium M attached to the guide surface 331 from the guide surface 331. Furthermore, when a transportation defect occurs, the vibration unit 336 is driven, causing the guide surface 331 to vibrate and thus the medium M attached to the guide surface 331 to readily separate from the guide surface 331.

In this way, the medium M changes from the state in which transportation defect has occurred, indicated by the two-dot chain line in FIG. 6, to a state in which the transportation defect is resolved, indicated by the solid line in FIG. 6. Specifically, the attachment of the medium M to the guide surface 331 and the lifting of the medium M from the guide surface 331 are resolved, and the transportation defect of the medium M on the guide surface 331 is resolved.

Incidentally, when the first blowing unit 69 is driven under the second driving conditions, the direction in which the high-temperature air rises in the heating region HA and the direction of airflow (second direction F2) that is produced in the heating region HA become opposite directions, making it difficult to increase the circulation efficiency of the high-temperature air. Thus, when the medium M is heated, the first blowing unit 69 is preferably driven under the first driving conditions.

Note that, when the transportation defect of the medium M is resolved, the first blowing unit 69 is driven under first driving conditions, and the driving of the second blowing unit 335 is stopped. Then, the interrupted printing of the medium M is resumed.

According to the exemplary embodiment described above, the following advantageous effects can be obtained.

(1) When a transportation defect of the medium M occurs in the heating region HA, an airflow is produced in the transport direction Y (first direction F1) in the heating region HA. This makes it possible to apply a force that moves the section where the transportation defect of the medium M occurred in the transport direction Y. Thus, even when a transportation defect of the medium M occurs in the heating region HA, the section where the transportation defect occurred is moved in the transport direction Y, making it possible to easily resolve the transportation defect.

Further, when a transportation defect of the medium M has not occur in the heating region HA and the medium M on which printing has been performed is heated, an airflow is produced in the direction (second direction F2) opposite to the transport direction Y in the heating region HA. That is, in this case, the direction in which high-temperature air rises in the heating region HA and the direction of airflow produced in the heating region HA by the first blowing unit 69 coincide, thereby improving the ease at which the high-temperature air circulates and making it possible to heat the medium M and the ink discharged onto the medium M efficiently by heat transmission.

(2) The driving conditions of the first blowing unit 69 can be switched on the basis of the detection result from the detecting unit 65. Thus, when a transportation defect occurs in the heating region HA during the heating of the medium M on which printing has been performed and the medium M is guided on the guide surface, the transportation defect can be resolved without the user switching the driving conditions of first blowing unit 69.

(3) When a transportation defect occurs in the heating region HA, the second blowing unit 335 is driven, causing air to blow out from the slit holes 337 formed in the guide surface 331. This makes it possible to separate the medium M attached to the guide surface 331, and thus easily resolve the transportation defect that occurred in association with attachment of the medium M to the guide surface 331. Further, formation of the slit holes 337 allows the vapor of the solvent components of the ink discharged onto the medium M to escape therethrough, making it possible to suppress condensation on the guide surface 331.

(4) When each of the slit holes 337 is a vertical slit hole with the transport direction Y serving as the longitudinal direction, both end portions of the medium M in the width direction X decline into the vertical slit holes in the transport direction Y, possibly causing a transportation defect of the medium M. Further, when each of the slit holes 337 is a horizontal slit hole with the width direction X serving as the longitudinal direction, a leading end portion of the medium M declines into the horizontal slit holes in the width direction X, possibly causing a transportation defect of the medium M. In response, in the exemplary embodiment, each of the slit holes 337 is a slit hole in which a direction formed between the width direction X and the transport direction Y serves as the longitudinal direction, making the end portions of the medium M less susceptible to decline into the slit holes 337 and thus transportation defects are less likely to occur.

(5) When the medium M becomes attached to the guide surface 331, causing a transportation defect, the guide surface 331 is vibrated by the vibration unit 336. This makes it possible to separate the medium M from the guide surface 331 and more easily resolve the transportation defect compared to when the transportation defect is resolved by the airflow produced in the heating region HA alone.

(6) The guide surface forming member 332 is heated, making it possible to directly heat the ink discharged onto the medium M by the infrared rays irradiated from the heater 63, unlike when the medium M transported on the guide surface 331 is heated. Thus, the temperature rise of the medium M is suppressed, making it possible to suppress deformation of the medium M as well as the occurrence of wrinkles in the medium M in association of the heating of the medium M.

The exemplary embodiment described above may be modified as follows.

When a transportation defect occurs (step S11: Yes), the control unit 70 may stop the drive of the heater 63.

When a transportation defect has not occurred, the control unit 70 may stop the first blowing unit 69.

The control unit 70 may not determine whether or not a transportation defect of the medium M has occurred in the heating region HA on the basis of the temperature of the detection region. For example, a displacement sensor that measures the lift of the medium M from the guide surface 331 may be provided, and the control unit 70 may determine whether or not a transportation defect of the medium M has occurred in the heating region HA in response to the amount of lift of the medium M.

The ink may include a resin for forming a film on the printing surface or a hardening agent that hardens the printing surface. In this case, when the medium M onto which the ink has been discharged is heated by the heating unit 60, the resin melts, forming a film, or the hardening agent reacts, hardening the printing surface. That is, the heating unit 60 is not configured to only dry the medium M on which printing has been performed.

The vibration unit 336 may not be provided, and the slit holes 337 (air blowout holes) may not be formed. In this case as well, a transportation defect of the medium M can be resolved by the airflow in the second direction F2 produced in the heating region HA.

The slit holes 337 may be circular holes or may be holes that form another shape.

The heating unit 60 may be provided with a filter that traps the vapor components included in the circulated air.

While the heating unit 60 contactlessly heats the medium M by thermal radiation in the exemplary embodiment described above, the heating performed is not limited thereto. For example, the heating unit 60 may heat the medium M by heat transmission alone. Furthermore, the heating unit 60 may heat the medium M by microwave heating (microwave drying).

In addition to a sheet, the medium M may be fiber, leather, plastic, wood, or ceramic.

The discharge unit 53 may be a so-called line head in which a nozzle row is formed having a length greater than or equal to the length of the medium M, and which is fixedly disposed on the printing apparatus 10, in the width direction X.

In the exemplary embodiment, the recording material used in the printing may be a fluid other than ink (including, for example, liquids, liquid materials obtained by dispersing or mixing particles of a functional material in a liquid, fluid materials like a gel, and solids that can flow and be discharged as a fluid). For example, a configuration is possible in which recording is performed by discharging a liquid material that includes material such as electrode material, color material (pixel material), or the like used in the manufacture of liquid crystal displays, electroluminescence (EL) displays, surface emitting displays, and the like in a dispersed or dissolved form.

In the exemplary embodiment, the printing apparatus 10 is not limited to a printer that records by discharging ink. Examples thereof include non-impact printers such as laser printers, LED printers, thermal transfer printers (including sublimation type printers); and impact printers such as dot matrix printers and the like.

This application claims priority under 35 U.S.C. §119 to Japanese Patent Application No. 2016-129020, filed Jun. 29 2016. The entire disclosure of Japanese Patent Application No. 2016-129020 is hereby incorporated herein by reference.

What is claimed is:

1. A printing apparatus, comprising:
a printing unit configured to print on a medium;
a transport unit configured to transport the medium in a transport direction;
a guide unit increasingly directed vertically downward while advancing in the transport direction and includes a guide surface configured to guide the medium on which printing has been performed by coming into contact with the medium; and
a heating unit disposed to face the guide surface with a space therebetween and configured to contactlessly heat the medium;
the heating unit including:
a first opening portion that opens toward the guide surface on an upstream side in the transport direction;
a second opening portion that opens toward the guide surface on a downstream side in the transport direction;
a duct connecting the first opening portion and the second opening portion; and
a blowing unit disposed inside the duct and capable of switching a blowing direction inside the duct, wherein
a direction of airflow produced in a heating region between the guide surface and the heating unit is switched in response to the switching of the blowing direction of the blowing unit.

2. The printing apparatus according to claim 1, further comprising:
a detecting unit configured to detect a transportation defect of the medium in the heating region, wherein
the blowing unit is driven under first driving conditions when a transportation defect of the medium is not detected in the heating region, and under second driving conditions when a transportation defect of the medium is detected in the heating region;
the first driving conditions is defined as the blowing unit blowing air inside the duct from the first opening portion toward the second opening portion, and
the second driving conditions is defined as the blowing unit blowing air inside the duct from the second opening portion toward the first opening portion.

3. The printing apparatus according to claim 1, wherein the guide surface includes an air blowout hole configured to blow out air toward the heating region.

4. The printing apparatus according to claim 3, wherein the air blowout hole is a slit hole provided in a plurality to the guide surface, and is arranged with a direction formed between a width direction and the transport direction of the medium serving as a longitudinal direction.

5. The printing apparatus according to claim 2, wherein:
the guide surface includes an air blowout hole configured to blow out air toward the heating region.

6. The printing apparatus according to claim 5, wherein the air blowout hole is a slit hole provided in a plurality to the guide surface, and is arranged with a direction formed between a width direction and the transport direction of the medium serving as a longitudinal direction.

7. The printing apparatus according to claim 1, further comprising a vibration unit configured to vibrate the guide surface.

8. The printing apparatus according to claim 2, further comprising a vibration unit configured to vibrate the guide surface.

9. The printing apparatus according to claim 3, further comprising a vibration unit configured to vibrate the guide surface.

10. The printing apparatus according to claim 4, further comprising a vibration unit configured to vibrate the guide surface.

11. The printing apparatus according to claim 5, further comprising a vibration unit configured to vibrate the guide surface.

12. The printing apparatus according to claim 6, further comprising a vibration unit configured to vibrate the guide surface.
